(19) United States
(12) Patent Application Publication
(10) Pub. No.: US 2025/0074808 A1
(43) Pub. Date: Mar. 6, 2025

(54) MOLTEN GLASS DELIVERY FUNNEL WITH GAS PERMEABLE CONDUIT

(71) Applicant: Owens-Brockway Glass Container Inc., Perrysburg, OH (US)

(72) Inventor: Stephen M. Graff, Maumee, OH (US)

(21) Appl. No.: 18/458,138

(22) Filed: Aug. 29, 2023

(51) Int. Cl. C03B 7/14; C03B 7/084

(52) U.S. Cl. CPC C03B 7/14; C03B 7/084

(57) ABSTRACT

A molten glass delivery funnel includes a gas permeable conduit. The gas permeable conduit is comprised of a gas permeable material such that a centering gas can flow permeably through the conduit and into an interior passage of the conduit. The permeable flow of the centering gas is able to displace a molten glass charge falling through the conduit away from an interior surface of the conduit and to create a gas cushion between the glass charge and the conduit.

### TECHNICAL FIELD

This patent application discloses innovations related to glass manufacturing and, more particularly, to a molten glass delivery funnel for delivering charges of falling molten glass.

### BACKGROUND

Glass container manufacturing processes typically include the following general process steps: (a) melting raw materials in a glass furnace or melter to produce molten glass; (b) producing a discrete portion or charge of the molten glass, such as a “gob,” by flowing a stream of the molten glass out of a glass feeder and cutting the stream to produce the molten glass charge; (c) delivering the molten glass charge to a blank mold of a glass container forming machine that forms the molten glass charge into a “parison” or a partially-formed container; (d) opening the blank mold and transferring the parison to a blow mold of the glass container forming machine; and (c) blowing the parison against internal walls of the blow mold to form a glass container. In conventional processes, the molten glass charges are delivered from the glass feeder to their respective blank molds by gob delivery equipment that includes a lengthy and widespread series of scoops, troughs, deflectors, and funnels that rely to some extent on gravity to move the charges through the system. In other processes, the glass charges may be delivered directly from the glass feeder to their respective blank molds.

To help guide the molten glass charges leaving the feeder along a desired trajectory, a delivery or loading funnel is typically located underneath the feeder below the shears or other cutting device that cut streams of glass into the glass charges. The feeder aligns the glass charges and keeps them from tipping off axis, for example, upon entry of the charges into a scoop or directly into a blank mold. More specifically, the delivery funnel orients the glass charges such that a falling axis of each glass charge tends to align with an inlet axis of the scoop or blank mold. Delivery funnels are typically made of stainless steel and are water cooled. The funnels are heavy mechanisms that need to be positioned properly and supported on a movable mounting so that the funnels can be swung or translated out the way of falling glass to, for instance, perform maintenance on the shears of feeder or to correct water flow issues in the funnels. As an alternative to stainless steel funnels, graphite funnels are also an option. However, graphite extracts heat out of the glass charges and is susceptible to wear from the gobs abrading the relatively soft interior surface of the graphite.

### SUMMARY OF THE DISCLOSURE

One embodiment of a molten glass delivery funnel includes a gas permeable conduit having an inlet end that defines an inlet, an outlet end that defines an outlet, and a sidewall that extends between the inlet end and the outlet end. The sidewall has an inner surface that defines an interior passage extending from the inlet to the outlet, and an outer surface. Additionally, the gas permeable conduit is comprised of a gas permeable material having a permeability between 10 md and 600 md and a thermal conductivity that is greater than or equal to 40 W/m-° K over the temperature range of 100° C.-300° C.

Another embodiment of a molten glass delivery funnel includes a gas permeable conduit and an outer wall. The gas permeable conduit defines an inlet, an outlet, and an interior passage extending between the inlet and the outlet. The gas permeable conduit is comprised of a gas permeable material having a permeability of at least 10 md and a thermal conductivity that is greater than or equal to 40 W/m-° K over the temperature range of 100° C.-300° C. The outer wall of the funnel cooperates with the gas permeable conduit to establish a gas distribution chamber between the gas permeable conduit and the outer wall. The outer wall defines at least one centering gas inlet and at least one centering gas outlet. Each of the centering gas inlet(s) and the centering gas outlet(s) are in fluid communication with the gas distribution chamber.

An embodiment of a method of delivering a molten glass charge through a delivery funnel includes receiving a molten glass charge into an interior passage of a gas permeable conduit through an inlet of the conduit, supplying a centering gas into the interior passage of the gas permeable conduit, by permeably flowing the centering gas through the gas permeable conduit, to displace the molten glass charge away from the conduit as the molten glass charge moves through the interior passage and to create a gas cushion between the molten glass charge and the conduit, and discharging the molten glass charge out of the interior passage of the gas permeable conduit through an outlet of the conduit.

### BRIEF DESCRIPTION OF THE DRAWINGS

FIG. 1 is a schematic view of a molten glass charge delivery track including a molten glass delivery funnel in accordance with an illustrative embodiment of the present disclosure;

FIG. 2 is an elevational view of the molten glass delivery funnel of FIG. 1 in accordance with an illustrative embodiment of the present disclosure and illustrating a gas permeable conduit and an outer wall;

FIG. 3 is a longitudinal cross-sectional view of the delivery funnel shown in FIG. 2;

FIG. 3A is an enlarged fragmentary perspective sectional view of a lower portion of the delivery funnel shown in FIG. 3 and illustrating a fluid path of the delivery funnel;

FIG. 4 is a longitudinal cross-sectional view of the delivery funnel depicted in FIG. 3 after the molten glass charge has fallen downwardly through the interior passage of the conduit, and further showing an enlarged schematic representation of the inner surface of the conduit; and

FIG. 5 is an elevational view of the gas permeable conduit shown in FIGS. 3 and 4.

### DETAILED DESCRIPTION

A molten glass delivery funnel that is used to orient and locate a molten glass charge, such as a glass gob, after the charge leaves a glass feeder is disclosed. The delivery funnel includes a gas permeable conduit. The gas permeable conduit facilitates delivery of the molten glass charge to its intended downstream destination and is more resistant to wear than conventional stainless steel and other graphite funnels, which reduces the need to replace or perform maintenance on the funnel. Specifically, the funnel establishes a gas distribution chamber around the gas permeable conduit that contains and is pressurized with a centering gas. The centering gas flows permeably through the gas permeable conduit and establishes a transient gas cushion that circumferentially surrounds and displaces the glass charge away from the conduit as the charge falls through the conduit, essentially allowing the charge to glide through the conduit while minimizing or altogether preventing direct contact between the glass charge and the gas permeable conduit, while also cooling the conduit. Although the delivery funnel will be disclosed and illustrated below in the context of facilitating delivery of a molten glass charge from a glass feeder to a scoop of conventional glass delivery equipment, the same delivery funnel may also be used in other applications such as to facilitate the direct loading of a molten glass charge from a glass feeder to a blank mold.

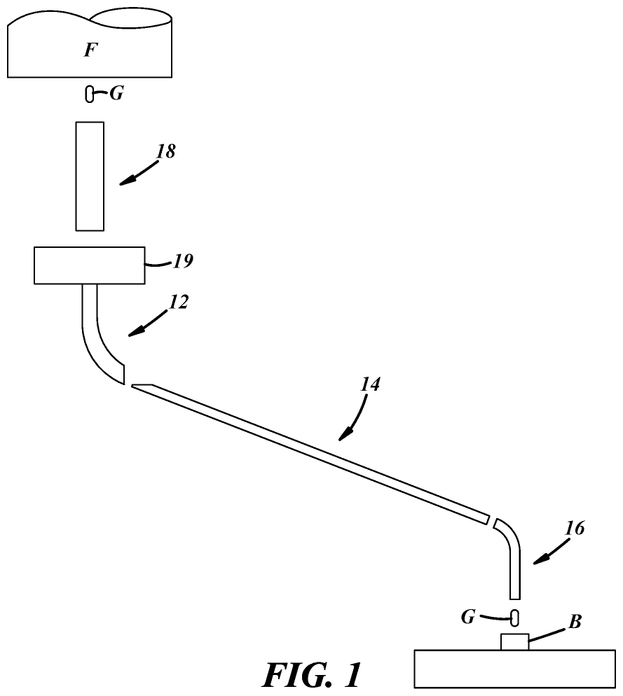

Turning now to the drawings, FIG. 1 depicts molten glass charge delivery track 10 that includes one or more guides such as, for example, a distributor scoop 12, a trough 14, and a deflector 16. The distributor scoop 12 receives a molten glass charge G from an overhead glass feeder F and conveys the glass charge G to the trough 14. The distributor scoop 12 has a vertical receiving section and a downstream curved section and may be rotatably driven by a distributor actuator 19 so that the scoop 12 can feed molten glass charges to a plurality of trough and deflector runs that, in turn, deliver glass charges to a plurality of corresponding glass container forming machines. The trough 14 receives the molten glass charge G from the distributor scoop 12 and conveys the glass charge G downstream to the deflector 16. The trough 14 is typically straight and is arranged to have a downward slope between the distributor scoop 12 and the deflector 16 to help convey the charge G. The deflector 16 receives the glass charge G from the trough 14 and delivers the charge G to a blank mold B of the glass container forming machine. The deflector 16 includes a curved section so that the charge G can be delivered into the blank mold B along a desired upright feeding axis. Although not separately illustrated, the glass feeder F may include one or more feeder orifices that dispense molten glass streams and one or more shears, lasers, or the like that separate the molten glass streams into the discrete charges G of molten glass.

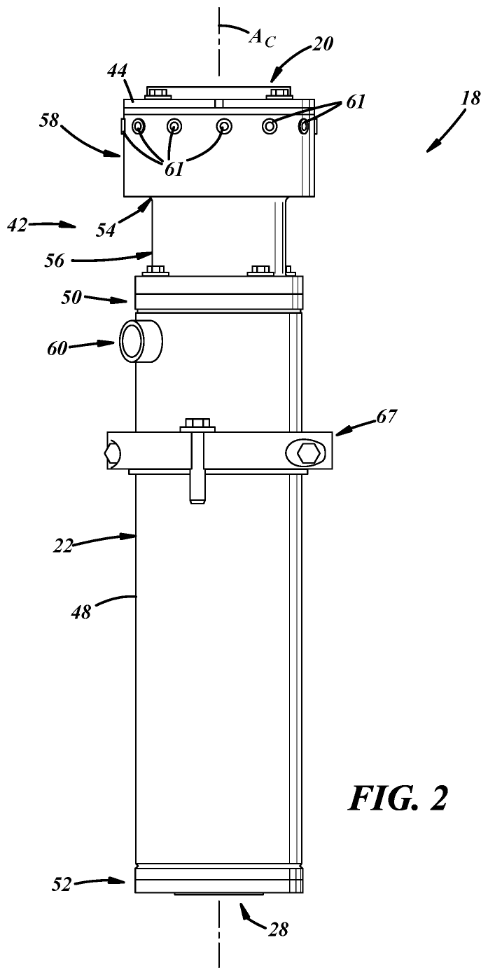

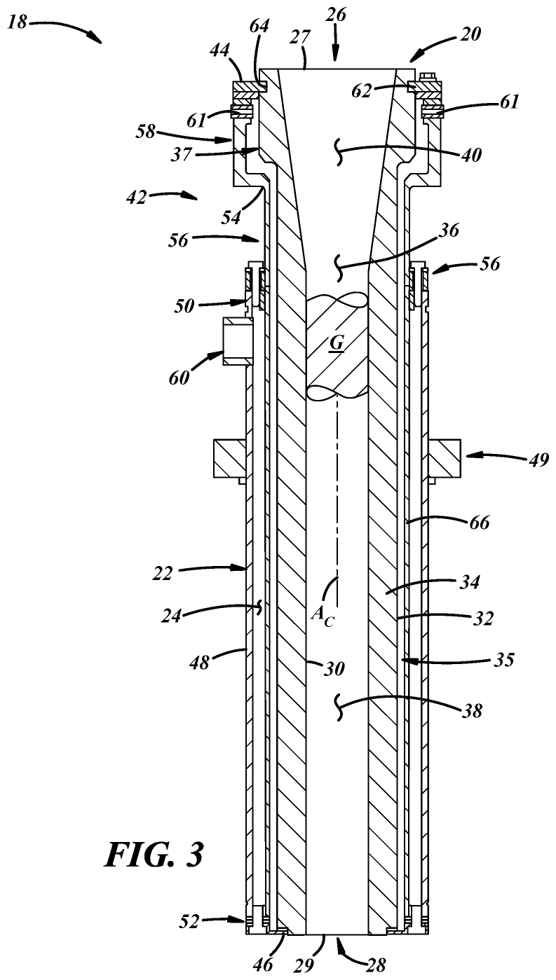

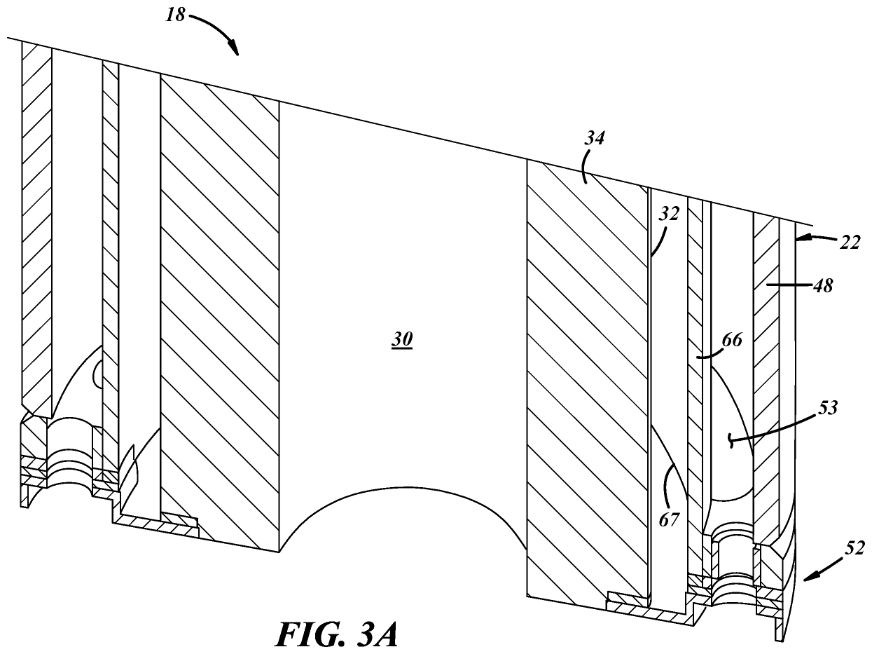

To help feed the molten glass delivery track 10, a delivery funnel 18 may be disposed beneath the glass feeder F to align the molten glass charges G for proper receipt by the distributor scoop 12. Referring now to FIGS. 2 and 3, a funnel 18 is illustrated as extending along a longitudinal conduit passage axis A_{C}, which may extend vertically or at an angle to vertical to account for misalignments between the delivery funnel 18 and the distributor scoop 12, for example. The delivery funnel 18 includes a gas permeable conduit 20 and an outer wall 22 that that is radially spaced apart from and surrounds the conduit 20 and may carry or be coupled to the conduit 20. The gas permeable conduit 20 is comprised of a gas permeable material. The material is “gas permeable” in the sense that a centering gas can diffusively flow through the interstitial porosity of the microstructure of the material when a pressure drop across the material exists. The outer wall 22 is preferably gas impermeable but in other embodiments may be comprised of a gas permeable material as well.

The gas permeable conduit 20 and the outer wall 22 cooperate to establish a gas distribution chamber 24 between the conduit 20 and the outer wall 22. The conduit 20 may be a circumferentially closed conduit that is circle-shaped or some other closed shape in normal cross-section. The outer wall 22 may also be circle-shaped or some other closed shape in normal cross-section and may be composed of a gas permeable material similar to the gas permeable conduit 20 or one that is less gas permeable than the material of the gas permeable conduit 20, or the outer wall 22 may be composed of a gas impermeable metal such as, for example, iron, mild steel, carbon steel, stainless steel, or aluminum or an aluminum alloy. The outer wall 22 may be fastened, crimped, adhered, or otherwise coupled to the gas permeable conduit 20 in any suitable manner, but is preferably configured as part of a larger device to carry the conduit 20 as will be described in greater detail below.

The gas permeable conduit 20 has an inlet end 26 defining an inlet 27, an outlet end 28 defining an outlet 29, and a sidewall 34 that extends between and provides the inlet end 26 and the outlet end 28 and defines a radial thickness of the conduit 20. The sidewall 34 has an inner surface 30 and an outer surface 32. The inner surface 30 defines an interior passage 36 through the conduit 20 that extends from the inlet 27 to the outlet 29. Moreover, the inner surface 30 and is the surface of the gas permeable conduit 20 that circumferentially surrounds the molten glass charge G as the charge G falls through the conduit 20 and through which the centering gas flows permeably into the interior passage 36. The inlet 27 and outlet 29 may be coaxial with, and lie in a plane perpendicular to, the longitudinal conduit passage axis A_{C}, as shown in the illustrated embodiment.

In operation of the delivery funnel 18, the molten glass charge G is received into the interior passage 36 of the conduit 20 through the inlet 27 and is discharged out of the interior passage 36 through the outlet 29. The outer surface 32 of the gas permeable conduit 20 is exposed to the centering gas, which is pressurized within the gas distribution chamber 24. And, because of the gas permeability of the conduit 20, the centering gas flows permeably through the conduit 20 from the outer surface 32 to the inner surface 30. The permeable flow of the centering gas into the interior passage 36 of the conduit 20 creates a gas cushion moves transiently with the molten glass charge G as the charge G falls through the conduit 20 to displace the charge G away from the inner surface 30 and help center the charge G within the interior passage 36. In this way, sustained direct sliding contact between the glass charge G and the inner surface 30 of the conduit 20 is minimized or avoided by resisting glass flow towards the inner surface 30. The permeable flow of the centering gas through the gas permeable conduit 20 also helps cool and maintain the conduit 20 at a target operating temperature ranging from 100° C. to 300° C. or, more narrowly, from 100° C. to 200° C., along the inner surface 30 of the conduit 20.

The interior passage 36 defined by the gas permeable conduit 20 includes a lower portion 38 and an upper portion 40. The lower portion 38 may be cylindrical and have a constant diameter or cross-sectional flow area measured perpendicular to the longitudinal conduit passage axis A_{C}, and the upper portion 40 may be tapered to have a variable diameter or cross-sectional flow area that narrows along the conduit passage axis A_{C} from the inlet 27 towards the outlet 29. The tapering of the upper portion 40 serves to guide the falling molten glass charge G from the inlet 27 down into the lower portion 38 of the interior passage 36. Of course, the upper portion 40, if tapered, would provide the inlet 27 with a larger cross-sectional flow area than that of the outlet 29. The sidewall 34 may be of circular cylindrical shape along its outer surface 36, as illustrated, or may be of ovular cylindrical shape, or of any other shape suitable for receiving, conveying, and transmitting the molten glass charge G. The gas permeable conduit 20 may be a unitary or monolithic piece, as shown, or assembled from multiple parts. The sidewall 34 may be of uniform wall thickness over a length of the lower portion 38 of the passage 36, and may be of variable wall thickness over a length of the upper portion 40 of the passage 36. More particularly, the sidewall 34 may include a main body 35, which includes the outlet end 28 and provides at least part of the lower portion 38 of the interior passage 36, and an enlarged head 37 extending from the main body 35, which includes the inlet end 26 and provides at least part of the upper portion 40 of the interior passage 36. The enlarged head 37 is greater in diameter than that of the main body 35.

The funnel 18 may also include a conduit carrier 42 that holds the gas permeable conduit 20. The conduit carrier 42 may include the outer wall 22 that surrounds and is radially spaced from the gas permeable conduit 20. The conduit carrier 42 may also include upper and lower mounting rings 44, 46 that are fastened or otherwise coupled to the outer wall 22 and engaged to corresponding portions of the gas permeable conduit 20. The outer wall 22 may include a first tubular body 48 and upper and lower caps 50, 52 that may be fastened, welded, threaded, or otherwise coupled to corresponding ends of the tubular body 48 to at least partially establish the gas distribution chamber 24 between the outer wall 22 and the conduit 20 to which the centering gas is supplied. The outer wall 22 may also include a second tubular body 54 extending upwardly with respect to the first tubular body 48 and may include a lower end 56 fastened or otherwise coupled to the upper cap 50 of the first tubular body 48 and an upper end 58 carrying or coupled to the upper mounting ring 44. The gas distribution chamber 24 may be supplied with the centering gas through at least one centering gas inlet 60 defined in the outer wall 22 such as, for example, in the first tubular body 48 of the wall 22, and may be relieved of the centering gas through at least one centering gas outlet 61 defined in the outer wall 22 such as, for example, in the second tubular body 54 of the wall 22. And, of course, the centering gas inlet(s) 60 may be in fluid communication with a centering gas supply (not shown), and each of the centering gas inlet(s) 60 and the centering gas outlet(s) 61 may be in fluid communication with the gas distribution chamber 24. The centering gas supplied to the gas distribution chamber 24 is preferably air, but other gases may be used including, for example, argon nitrogen, or any other gas suitable for contact with molten glass, and the pressure of the centering gas in the gas distribution chamber 24 preferably ranges from 1 psig to 100 psig and, more narrowly, from 10 psig and 40 psig.

The upper mounting ring 44 may be fastened, welded, threaded, or otherwise coupled to the upper end 58 of the second tubular body 54 and may have one or more radially inwardly extending tongues 62 that fit into one or more corresponding grooves 64 in the gas permeable conduit 20. To facilitate assembly of such a tongue-and-groove connection, the upper mounting ring 44 may be split, and constituted from semi-circumferential halves. The lower mounting ring 46 and mounting arrangement to the gas permeable conduit 20 may be similar to that of the upper mounting ring 44. When the conduit carrier 42 is assembled around the gas permeable conduit 20, the gas distribution chamber 24 established between the outer wall 22 and the conduit 20 is exposed to and covers at least 85%, or more preferably at least 90% or even at least 95%, of the outer surface 32 of the conduit 20. This ensures that a sufficient portion of the outer surface 32 of the gas permeable conduit 20 is exposed to the pressurized centering gas in the gas distribution chamber 24 to support the permeable flow of the centering gas through the conduit 20 and into the interior passage 36.

The conduit carrier 42 also may include a baffle 66 located radially between the gas permeable conduit 20 and the outer wall 22 to help distribute and direct the centering gas supplied through the outer wall 22 to the gas permeable conduit 20. The baffle 66 may establish a circuitous path for the flow of the centering gas within the gas distribution chamber 24. More specifically, in one possible implementation, the centering gas enters the gas distribution chamber 24 through the centering gas inlet 60 defined in the outer wall 22, flows circumferentially around the baffle 66 and, with additional reference to FIG. 3A, down to a lower end 67 of the baffle 66 proximate the lower cap 52 that may have one or more gas passages 53 in the form of holes, slots, reliefs, or gaps. The centering gas flows through the gas passages 53 around the lower end 67 of the baffle 66, radially inwardly toward the gas permeable conduit 20, and circumferentially around the conduit 20 between the conduit 20 and the baffle 66 and up and out of the gas distribution chamber 24 through one or more centering gas outlets 61 defined in the outer wall 22, which are sized or otherwise configured to maintain a suitable pressure within the gas distribution chamber 24 and to provide a vent for hot gasses to exit the chamber 24. The baffle 66 promotes more uniform impingement of the centering gas circumferentially over the entire outer surface 32 of the gas permeable conduit 20 and allows for the pressure differential across the conduit 20 between the outer surface 32 and the inner surface 30 to be more uniform, thus helping produce more uniform permeable centering gas flow through the conduit 20 along the length of the conduit 20. Portions of the baffle 66 may be welded, fastened, interference fit, or otherwise coupled to corresponding portions of the outer wall 22.

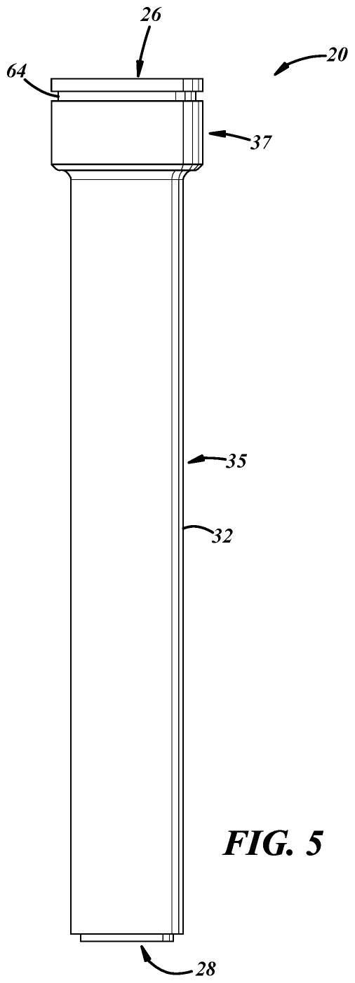

The conduit carrier 42 may further include one or more mounting flanges 49 that may be used to hold the funnel 18 in any desired position and location such as within a funnel holder (not shown). Here, the mounting flanges project radially from the outer wall 22 and, in particular, the first tubular body 48 of the outer wall 22. The funnel 18 can be adapted for use with any suitable pneumatic fittings, lines, adapters, valves, and the like, and can be coupled to any suitable source of pneumatic gas to supply the centering gas into the gas distribution chamber 24 of the funnel 18. Moreover, the configurations of, and various subcomponents for the funnel 18, can vary depending on the desired implementation, and need not take the exact form illustrated herein. Rather, the embodiment illustrated in FIGS. 1-5 is meant to provide an example configuration that is particularly useful with the gas-permeable material described below.

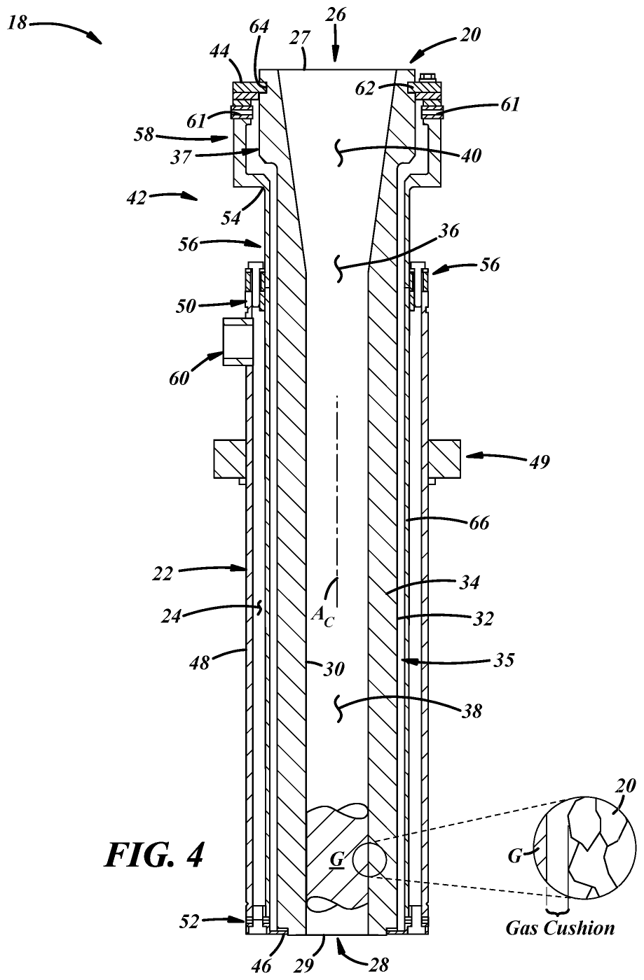

A schematic representation of the molten glass charge G being displaced radially inwardly around its entire circumference within the interior passage 36 of the gas permeable conduit 20 by the permeable flow of the centering gas is illustrated in FIGS. 3-4. In FIG. 3, the molten glass charge G is depicted in the lower portion 38 of the interior passage 36 after having entered the passage 36 through the inlet 27 of the gas permeable conduit 20. While the molten glass charge G is moving through the lower portion 38 of the interior passage 36, the centering gas flowing permeably through the conduit 20 from the gas distribution chamber 24 exerts a pushing force on the glass gob G, as depicted in in FIG. 4, to displace the glass charge G away from the inner surface 30 and create a gas cushion between the charge G and the inner surface 30. The gas cushion minimizes or altogether prevents abrasive contact between the molten glass charge G and the inner surface 30 of the gas permeable conduit 20 and also disrupts heat flow out of the charge G and into the conduit 20. And to the extent the molten glass charge G may make intermittent contact with the inner surface 30 of the gas permeable conduit 20, the centering gas quickly breaks such contact and a lubricious property of the conduit 20 is helpful to prevent slowing of the glass charge G in the conduit 20.

The gas permeable material from which the gas permeable conduit 20 is constructed allows for the centering gas to flow permeably through natural interstitial porosity of the material from the gas distribution chamber 24 and into the interior passage 36. The gas permeable material is selected so that the centering gas can flow permeably through the gas permeable conduit 20 at a sufficient flux to create the gas cushion and achieve good performance in terms of mitigating wear of the inner surface 30 of the conduit 20. The permeable flow rate through the gas permeable material of the gas permeable conduit 20 (for the range of thickness the conduit 20 may assume) is dictated primarily by (i) the pressure differential across the gas permeable material, which, in the conduit 20, is attained by controlling the pressure of the centering gas within the gas distribution chamber 24, and (ii) the permeability of the material. To achieve sufficient permeable flow of the centering gas through the conduit 20, particularly at gas pressures within the gas distribution chamber 24 that range from 1 psig to 100 psig, the gas permeable material preferably has a permeability (k) of at least 10 millidarcy (md), at least 50 md, at least 100 md, at least 120 md, at least 150 md, or at least 200 md, with some example permeability ranges being 10 md to 600 md or, more narrowly, from 50 md to 500 md, from 100 md to 400 md, or from 110 md to 600 md when measured according to the ASTM D4525-13 Standard. The term “permeability” as used herein is a proportionality constant and is often used synonymously with the term “coefficient of permeability,” as in the ASTM D4525-13 Standard, or the “permeability coefficient.”

The gas permeable material is also preferably thermally conductive so that the material can distribute heat and thus inhibit the formation of localized hot spots on the inner surface 30 of the gas permeable conduit 20, which can help reduce abrasion of the inner surface 30 by the continuous passage of molten glass charges G. Specifically, when the thermal conductivity of the gas permeable material is greater than or equal to 40 W/m-° K or, more specifically, greater than or equal to 60 W/m-° K or even greater than 100 W/m-OK, over the temperature range of 100° C.-300° C., which spans the preferred target operating temperature of the gas permeable conduit 20 when in use, the gas permeable material can better resist glass adhesion and abrasion along the inner surface 30 of the conduit 20. In certain embodiments, the thermal conductivity of the gas permeable material is preferably between 100 W/m-° K and 200 W/m-OK or, more narrowly, between 130 W/m-° K and 180 W/m-° K over the same temperature range (i.e., 100° C.-300° C.) just mentioned.

The gas permeable material may be a carbon-based material and, more preferably, a graphite-based material. As used herein, “-based” refers to materials that are greater than or equal to 50 wt % of the designated material. For example, a graphite-based material may be pure graphite (100 wt %) or a mixture having graphite as the main constituent (50 wt % or greater) along with other materials. A graphite-based material is a particularly good candidate for the gas permeable material because graphite can achieve various levels of permeability and thermal conductivity depending on several factors including how the graphite is formed and processed. Another quality of graphite-based materials that may be useful in constructing the gas permeable conduit 20 is that graphite-based materials are self-lubricating, which renders the inner surface 30 less likely to both suffer abrasion and slow the speed of the glass charge G as it falls through the interior passage 36, especially in cooperation with the permeating flow of the centering gas into the interior passage 36. Another self-lubricating material that may be used as the gas permeable material is a boron nitride-based (BN-based) material and, more particularly, hexagonal boron nitride.

In one specific embodiment, the gas permeable material is composed of an extruded graphite. Extruded graphite can possess a relatively high permeability and thermal conductivity compared to other forms of graphite. Indeed, the entirety of the gas permeable conduit 20—that is, the entire sidewall 34 between the inlet and outlet ends 26, 28—may be composed of extruded graphite. Constructing the conduit 20 from extruded graphite may also provide some control over the porosity of the inner surface 30 of the conduit 20, which may help establish the desired permeability. One particularly useful extruded graphite that may be used to construct the gas permeable conduit 20 is identified as DT-585 and is available from DuraTemp Corporation (Holland, Ohio). Other forms of graphite may also be used to construct the gas permeable conduit 20 including isostatically molded graphite and vibratory molded graphite.

The delivery funnel 18 described above can be used to receive and deliver a charge of molten glass G for subsequent glass forming operations. For example, one method of delivering the molten glass charge G through the delivery funnel 18 via the gas permeable conduit 20 described above includes receiving the molten glass charge G into the interior passage 36 of the conduit 20 through the inlet 27 of the conduit 20, supplying a centering gas into the interior passage 36 permeably through the conduit 20 to displace the glass charge G away from the inner surface 30 of the conduit and create a gas cushion between the charge G and the inner surface 30 as the charge G moves through the interior passage 36, and discharging the glass charge G through the outlet 29 of the conduit 20. The centering gas flows permeably through the conduit 20 from the gas distribution chamber 24. As such, as part of the method, the centering gas may be supplied to the gas distribution chamber 24 from a centering gas source and the pressure of the gas within the chamber 24 may be controlled. By controlling the pressure of the centering gas in the gas distribution chamber 24, the permeable flow rate of the centering gas through the gas permeable conduit 20 and into the interior passage 36 can be controlled; indeed, increasing the pressure in the gas distribution chamber 24 results in an increase in the permeable flow rate of the centering gas through the conduit 20 while decreasing the pressure results in a decrease in the permeable flow rate. Molten glass charges G may be delivered by the delivery funnel 18 to a distributor scoop 12 or directly to a blank mold M of a glass container forming machine, as discussed above.

As used in herein, the terminology “for example,” “e.g.,” for instance,” “like,” “such as,” “comprising,” “having,” “including,” and the like, when used with a listing of one or more elements, is to be construed as open-ended, meaning that the listing does not exclude additional elements. Also, as used herein, the term “may” is an expedient merely to indicate optionality, for instance, of a disclosed embodiment, element, feature, or the like, and should not be construed as rendering indefinite any disclosure herein. Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. The present disclosure is intended to embrace all such embodiments and modifications of the subject matter of this application, and equivalents thereto, as fall within the broad scope of the accompanying claims.

1. A molten glass delivery funnel comprising:
a gas permeable conduit having an inlet end that defines an inlet, an outlet end that defines an outlet, and a sidewall that extends between the inlet end and the outlet end, the sidewall having an inner surface that defines an interior passage extending from the inlet to the outlet, and an outer surface, wherein the gas permeable conduit is comprised of a gas permeable material having a permeability between 10 md and 600 md and a thermal conductivity that is greater than or equal to 40 W/m-° K over the temperature range of 100° C.-300° C.

2. The molten glass delivery funnel set forth in claim 1, wherein the permeability of the gas permeable material is between 50 md and 500 md.

3. The molten glass delivery funnel set forth in claim 1, wherein the permeability of the gas permeable material is between 110 md and 600 md and the thermal conductivity of the gas permeable material is between 100 W/m-° K and 200 W/m-° K over the temperature range of 100° C.-300° C.

4. The molten glass delivery funnel set forth in claim 1, wherein the gas permeable material is a graphite-based material.

5. The molten glass delivery funnel set forth in claim 4, wherein the gas permeable conduit is comprised entirely of graphite.

6. The molten glass delivery funnel set forth in claim 5, wherein the graphite is extruded graphite.

7. The molten glass delivery funnel set forth in claim 1, further comprising:
an outer wall that cooperates with the gas permeable conduit to establish a gas distribution chamber between the gas permeable conduit and the outer wall, the gas distribution chamber being pressurizable with a centering gas.

8. The molten glass delivery funnel set forth in claim 7, wherein the outer wall defines at least one centering gas inlet and at least one centering gas outlet, each of the at least one centering gas inlet and the at least one centering gas outlet being in fluid communication with the gas distribution chamber.

9. A molten glass delivery funnel, comprising:
a gas permeable conduit defining an inlet, an outlet, and an interior passage extending between the inlet to the outlet, wherein the gas permeable conduit is comprised of a gas permeable material having a permeability of at least 10 md and a thermal conductivity that is greater than or equal to 40 W/m-° K over the temperature range of 100° C.-300° C.; and
an outer wall that cooperates with the gas permeable conduit to establish a gas distribution chamber between the gas permeable conduit and the outer wall, the outer wall defining at least one centering gas inlet and at least one centering gas outlet, each of the at least one centering gas inlet and the at least one centering gas outlet being in fluid communication with the gas distribution chamber.

10. The molten glass delivery funnel set forth in claim 9, wherein the permeability of the gas permeable material is between 100 md and 400 md.

11. The molten glass delivery funnel set forth in claim 10, wherein the thermal conductivity of the gas permeable material is between 100 W/m-° K and 200 W/m-° K over the temperature range of 100° C.-300° C.

12. The molten glass delivery funnel set forth in claim 9, wherein the gas permeable material is a graphite-based material.

13. The molten glass delivery funnel set forth in claim 12, wherein the gas permeable conduit is comprised entirely of graphite.

14. The molten glass delivery guide set forth in claim 12, wherein the graphite-based material is extruded graphite.

15. A method of delivering a molten glass charge through a molten glass delivery funnel, the method comprising:
receiving a molten glass charge into an interior passage of a gas permeable conduit through an inlet of the conduit;
supplying a centering gas into the interior passage of the gas permeable conduit, by permeably flowing the centering gas through the gas permeable conduit, to displace the molten glass charge away from the conduit as the molten glass charge moves through the interior passage and to create a gas cushion between the molten glass charge and the conduit; and
discharging the molten glass charge out of the interior passage of the gas permeable conduit through an outlet of the conduit.

16. The method set forth in claim 15, wherein the gas permeable conduit is comprised of a gas permeable material having a permeability between 100 md and 400 md and a thermal conductivity that is greater than or equal to 40 W/m-° K over the temperature range of 100° C.-300° C.

17. The method set forth in claim 16, wherein the gas permeable material is a graphite-based material.

18. The method set forth in claim 15, further comprising:
controlling a permeable flow rate of the centering gas through the gas permeable conduit and into the interior passage of the conduit by controlling a pressure of the centering gas in a gas distribution chamber established around the gas permeable conduit.

19. The method set forth in claim 15, wherein the centering gas is air.
